(19) United States
(12) Patent Application Publication
(10) Pub. No.: US 2013/0078665 A1
(43) Pub. Date: Mar. 28, 2013

(54) Test strip, a test kit and a method for detection of endotoxin in food

(71) Applicants: Deepika Bodapati, Saratoga, CA (US); Belinda Elizabeth Lowe-Schmahl, San Jose, CA (US)

(72) Inventors: Deepika Bodapati, Saratoga, CA (US); Belinda Elizabeth Lowe-Schmahl, San Jose, CA (US)

(21) Appl. No.: 13/552,515

(22) Filed: Jul. 18, 2012

(51) Int. Cl. G01N 21/78

(52) U.S. Cl. 435/29

(57) ABSTRACT

A home test strip for detection of endotoxin in food, the test strip includes an amebocyte lysate component, a chromogenic substrate component, and a carrier matrix. The amebocyte lysate component and the chromogenic substrate component are located in close proximity to each other and further incorporated within the carrier matrix. A home test kit for detection of endotoxin in food is also provided, which includes a sample holding container for collecting and holding a sample, a test strip, a standard colour scale. A method for detection of endotoxin in food is further provided, which includes the steps of preparing a food sample, placing a test strip in the food sample, waiting for an instructed time prior to removing the test strip, observing the formation of any colour, and matching the intensity of colour formed against a standard colour scale for deciding safety of food for consumption.

### TECHNICAL FIELD

The embodiments herein generally relate to the field of health care and test kits for detection of toxins in food products. More particularly, the embodiments relate to a home test strip and a test kit for use by consumers for detecting the presence of endotoxin in food products using a Limulus Amebocyte Lysate (LAL)-based assay.

### BACKGROUND

Food is the principle source for providing nutrition, producing energy, maintaining life, and stimulating growth and hence, ensuring that the food we eat is harmless and free of contamination, is of utmost importance. Government regulatory agencies play an important role in establishing standards with regard to quality of food products being made available in the market. Strict compliance by industries and active enforcement by regulatory agencies ensures good quality of food products to the consumers. Though, the standards are strictly adhered to in certain parts of the world, adherence to these standards in other parts might be lacking or ignored. Today's global marketplace has also multiplied the problem. Contamination of food in one country can now easily result in a significant effect on public health in other parts of the world.

Amongst the various causes for contamination of food products leading to illnesses, presence of harmful bacteria in the food is the most common cause. Gram-negative bacteria are generally notorious for being harmful because of their pathogenic capabilities. The pathogenic capability of the Gram-negative bacteria is attributed to the presence of the lipopolysaccharide layer (also known as LPS or endotoxin layer) in cell wall of bacterial. The endotoxins present in the bacteria are responsible for eliciting a strong response from the immune system and has also led to fever, in mild cases, to deaths, in certain cases.

Detection of endotoxin is generally done using the horseshoe crab Limulus polyphemus which is particularly sensitive to endotoxin. Accordingly, the blood cells from horseshoe crab, termed “Limulus amebocyte lysate” or “LAL”, are employed widely in endotoxin assays because of the sensitivity, specificity, and relative ease for avoiding interference by other components that may be present in a sample. LAL, when combined with a sample containing bacterial endotoxin, reacts with the endotoxin to produce a product, for example, a chromogenic product that can be detected either visually or by the use of an optical detector.

Contamination of food can occur anytime during the stages of growing, harvesting, processing, storing, shipping, or at the time of preparation. Though, monitoring for endotoxin contamination at each and every stage of the supply chain is necessary, it is equally important for the end consumers to be able to detect the presence of endotoxin contamination prior to consuming the food. Laboratory tests for testing samples for endotoxin contamination using LAL are generally costly, complex and time consuming. Therefore, there is a need for a consumer based home test kit, which is compact, portable and simple to use for quick detection of endotoxin contamination in food products, prior to consumption, in order to prevent or minimize the possibility of illness, injury and death caused by the contamination of food and water.

### OBJECT OF INVENTION

The principal object of this invention is to provide a home test strip for the visual detection of endotoxins in food.

Another object of this invention is to provide a home test kit for the visual detection of endotoxins in food.

Another object of the invention is to enhance resulting colours obtained when using a home test kit for endotoxin detection in food.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a perspective view of the test strip according to an embodiment disclosed herein;

FIG. 2 is a flow chart showing a process for the detection of endotoxin in food according to an embodiment as disclosed herein;

FIG. 3 is a graph showing the difference in the absorption level of the diatom, before and after engulfing the LAL molecule, at different dilution levels; and

FIG. 4 is a graph showing the variation of absorption as the LAL molecules react with endotoxin.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments of present invention generally relate to a home test strip and a home test kit, which is compact, portable and simple to use for quick detection of endotoxin contamination in food products prior to consumption. Because of its small size, it can be used by the consumer at any location including their homes or in restaurants. Further, the test kit of the present invention can analyze small amounts of food samples, and can be implemented by consumers without extensive training in laboratory techniques. The present invention thus tries to prevent or substantially minimize the incidence of contamination of food caused due to endotoxins, while reducing the complexity of testing, the time needed to perform such tests and high costs involved.

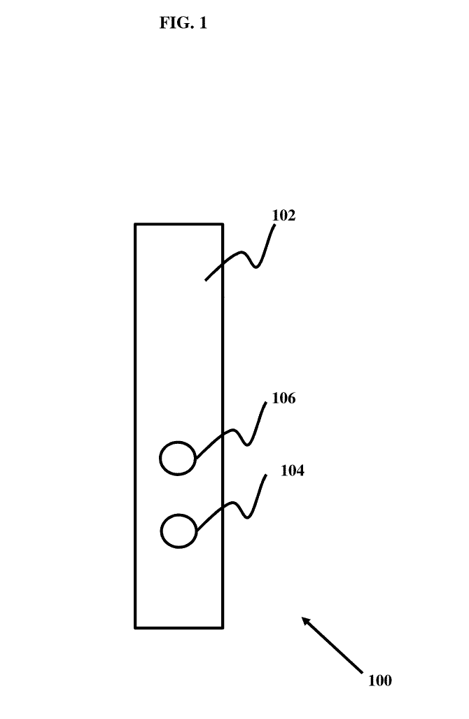

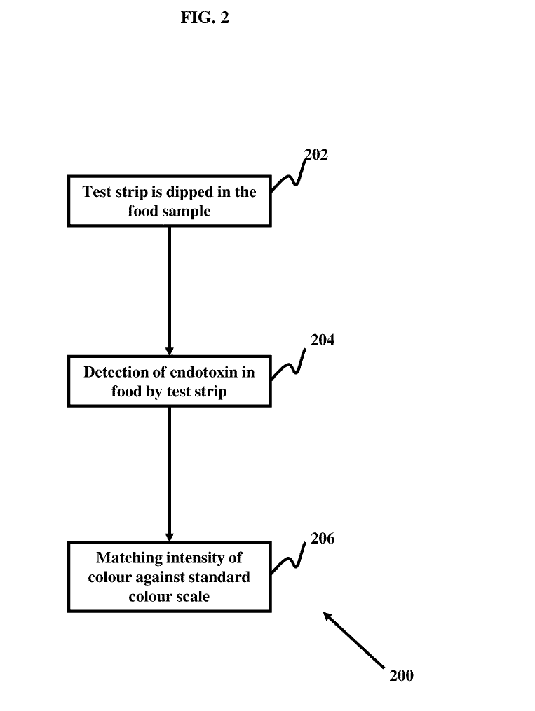

The embodiments herein provide a home test strip and a home test kit for the detection of endotoxin in food and a method for detection of endotoxin in food. Referring now to the drawings, and more particularly to FIGS. 1 through 2, where similar reference characters denote corresponding features consistently throughout the figures, there are shown embodiments.

FIG. 1 is a perspective view of the test strip according to an embodiment of the present invention. In an embodiment, the test strip 100 includes a carrier matrix 102, Limulus amebocyte lysate (LAL) component 104 incorporated with the carrier matrix 102, and a chromogenic substrate component 106 incorporated with the carrier matrix 102. In another embodiment, one end of the test strip 100 is covered so as to prevent a false reading, resulting out of contact between the hands of the user possibly containing endotoxins and the test strip 100.

Carrier matrix: The carrier matrix 102 is essentially a porous material which is inert to the components 104 and 106. Further, the carrier matrix 102 is absorbent relative to the food sample. The carrier matrix 102 should be insoluble in and maintain its structural integrity when exposed to water or to other physiological fluids. In one embodiment, carrier matrix 102 is a paper. In another embodiment, the carrier matrix 102 is a high grade filter paper such as those available from Whatman, Clifton, N.J. It is also within the scope of this invention to use other high grade filter papers as carrier matrix 102. In an embodiment, the components 104 and 106 are placed in close proximity to allow for a fluid communication across the carrier matrix 102 between the LAL component 104 and chromogenic substrate component 106. The test result is independent of the dimension of the components provided that the size of the components 104 and 106 is the same.

In an example, the LAL component 104 and chromogenic substrate 106 is around 4 cm in diameter. Further, the LAL component 104 and chromogenic substrate 106 are placed around 3 cm apart.

Limulus amebocyte lysate (LAL) component: Limulus amebocyte lysate (LAL) component 104 contains endotoxin-specific, horseshoe crab amebocyte lysate, whereby the sensitivity of the lysate is pre-adjusted to provide for minimum toxicity levels as prescribed by the food regulatory authorites. It is also within the scope of the invention to use other horseshoe crab amebocyte lysates as component 104 without otherwise deterring the intended function of component 104 that can be inferred from the description herein.

Chromogenic substrate component: Chromogenic substrate component 106 is used to visually identify the presence of endotoxins in the tested sample either with relatively simple inexpensive instrumentation or by visually comparing the colour with standard charts provided to the user. A number of chromogenic LAL substrates are being marketed for endotoxin LAL assays and can be used within the scope of this invention.

In another embodiment, to further enhance the brightness of the resulting colours, diatoms are placed on top of the chromogenic substances. In an embodiment, the diatoms are pen shaped. Diatoms having a length ranging from 9-28 micrometer and width ranging from 4-10 micrometer are selected. In an embodiment, the diatom is Diadesmis confervacea.

In an example, the diatoms were grown in different nutrient media. Tried media include: TSB CR1-S, CR1-SD, TSB, Sodium Silicate and control. TSB nutrient media was found to provide the best growth amongst the selected media. Results obtained are provided in Table 1.

TABLE 1

| Diatom Nutrient | Agarose | | Under the |
|---|---|---|---|
| Media | Method | Test Tube | Microscope |
| TSB | TMTC | Cloudy with thick | 3-5 developed |
| | | matter on bottom | diatoms found as |
| | | | well as premature |
| | | | diatoms |
| CR1-S | TMTC | Lightly clouded | 1-2 Diatoms found |
| | | | with many Diatom |
| | | | fragments |
| CR1-SD | Separated | Lightly clouded | 1-2 Diatoms found |
| | but many | | |
| TSB and Sodium | TMTC | Extremely clouded | 1-3 Diatoms found |
| Silicate | | with matter floating | |
| | | everywhere | |
| Control | none | No cloudiness | No diatoms found |

Further, different surfaces were tried for the growth of diatoms. Tried surfaces include: glass slides, plastic slides, cover slips, cuvettes. However, growing the diatoms on these surfaces led to diatoms growing over each other and leading to the loss of refractive index. Hence, diatoms were starved of silicon which led to growth of diatoms as flat membrane like layers which had better refractive index. Amongst, the different tried surfaces, glass slides provided for the best growth of diatoms across different media. Results obtained are provided in Table 2.

TABLE 2

| | | | Sodium |
|---|---|---|---|
| | Soil Media | TSB | Silicate + TSB |
| Cover slips | Minimal Growth | Substantial Growth | Various types |
| | | | of growth |
| Glass Slides | Substantial Growth | Abundant Growth | Various types |
| | | | of growth |
| Plastic | Minimal Growth | Substantial Growth | Various types |
| Slides | | | of growth |
| Cuvettes | Minimal Growth | Substantial Growth | Various types |
| | | | of growth |

In one embodiment, the placement of diatoms on top of the chromogenic substance is done by heat fixing. The use of diatoms provided for brighter colours for the same level of endotoxins being present in food. Further, the colours were also found to be consistent across multiple samples.

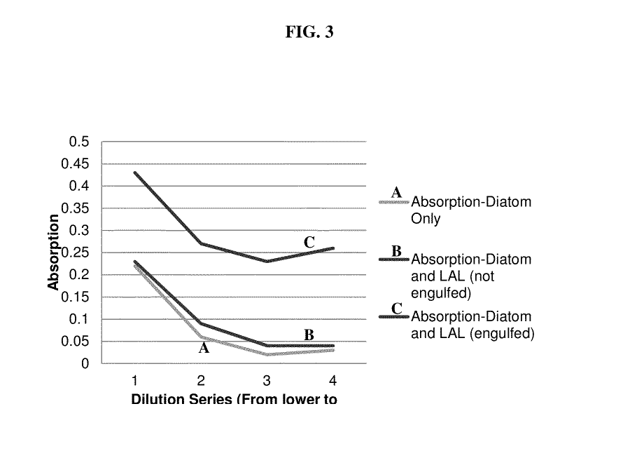

In an example, Spectrometer test was conducted without the inclusion of endotoxin to test the absorbance of light. LAL and diatoms on glass showed an absorbance value of 0.45. Whereas, LAL on glass and diatoms on glass showed 0.2. Further, at different dilutions, consistent difference in the absorption level of the diatoms before and after the engulfment of the LAL molecules by diatoms was observed, which has been depicted in FIG. 3.

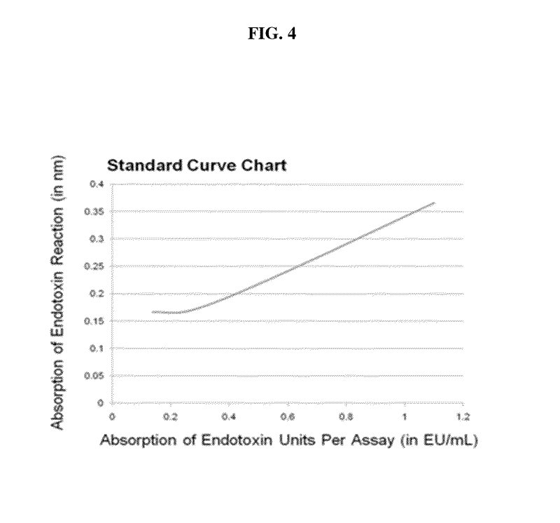

Furthermore, greater concentration of LAL was found to result in higher absorption levels, as depicted in FIG. 4, which shows a graph depicting the variation of absorption as the LAL molecules react with endotoxin.

FIG. 2 depicts a block diagram for a method for the detection of endotoxin in food according to an embodiment of the present invention. In an embodiment, a small quantity of food is taken as a food sample for conducting the tests for detecting the presence of endotoxins. Based on the consistency of the food to be tested, the food sample is either grinded, blended, crushed or a small amount of liquid is added to ensure that the test strip can be dipped inside the food sample and a fluid communication across the carrier matrix may be established. In an embodiment, the liquid which is added is water. In an embodiment, the test strip 100 is dipped in food sample (step 202) for a prescribed period of time to allow for a fluid communication across the carrier matrix 102 between the LAL component 104 and chromogenic substrate component 106. Presence of endotoxin in food is detected (step 204) by the LAL component 104 of the test strip 100 and a colour is obtained anywhere between the LAL component 104 and the chromogenic substrate component 106. The intensity of colour is matched (step 206) against a standard colour scale to determine the concentration of endotoxins present in food and estimated safety of food product for consumption. In one embodiment, diatoms are heat fixed on top of the chromogenic substances which help provide brighter colours for the same level of endotoxins being present in food. In another embodiment, methods for detecting the presence of endotoxins include spreading the test strip 100 on the liquid food solution or spaying the liquid food solution over the test strip 100.

In another embodiment, a test kit is provided which includes a test strip 100 and a sample holding container (not shown) and a standard colour scale (not shown).

In an embodiment, the test for endotoxin was found to be consistent across a wide range of temperature ranging from 11 degree C. to 37 degree C. In a specific embodiment, the test is performed at room temperature.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A test strip apparatus for detection of endotoxin in food, the test strip comprising of:
an amebocyte lysate component;
a chromogenic substrate component; and
a carrier matrix,
wherein the amebocyte lysate component and the chromogenic substrate component are located in close proximity to each other and further incorporated within the carrier matrix.

2. The test strip as claimed in claim 1, wherein the amebocyte lystate is Limulus amebocyte lysate.

3. The test strip as claimed in claim 1, wherein the chromogenic substrate component further comprises of placement of diatoms on top of the chromogenic substrate component.

4. The test strip as claimed in claim 1, wherein the carrier matrix is paper.

5. The test strip as claimed in claim 4, wherein the paper is a high grade filter paper.

6. A test kit for detection of endotoxin in food, the test kit comprising of:
a sample holding container for collecting and holding a sample;
a test strip, the test strip further comprising of an amebocyte lysate component and a chromogenic substrate component located in close proximity to each other and further incorporated within a carrier matrix; and
a standard colour scale.

7. The test kit as claimed in claim 6, wherein the amebocyte lystate is Limulus amebocyte lysate.

8. The test kit as claimed in claim 6, wherein the chromogenic substrate component further comprises of placement of diatoms on top of the chromogenic substrate component.

9. The test kit as claimed in claim 6, wherein the carrier matrix is paper.

10. The test kit as claimed in claim 9, wherein the paper is a high grade filter paper.

11. A method for detection of endotoxin in food, the method comprising:
preparing a food sample;
placing a test strip in the food sample, the test strip further comprising of an amebocyte lysate component and a chromogenic substrate component located in close proximity to each other and further incorporated within a carrier matrix;
waiting for an instructed time prior to removing the test strip; and
matching the intensity of colour formed against a standard colour scale.

12. The method for the detection of endotoxin as claimed in claim 11, wherein the amebocyte lystate is Limulus amebocyte lysate.

13. The method for the detection of endotoxin as claimed in claim 11, wherein the chromogenic substrate component further comprises of placement of diatoms on top of the chromogenic substrate component.

14. The method for the detection of endotoxin as claimed in claim 11, wherein the carrier matrix is paper.

15. The method for the detection of endotoxin as claimed in claim 14, wherein the paper is a high grade filter paper.
